(19) United States
(12) Patent Application Publication
(10) Pub. No.: US 2007/0097589 A1
(43) Pub. Date: May 3, 2007

(54) Method of preadjusting an electromagnetic actuator

(75) Inventor: Christophe Maerky, Saint Ouen L'Aumone (FR)

Correspondence Address: BIRCH STEWART KOLASCH & BIRCH, PO BOX 747, FALLS CHURCH, VA, 22040-0747, US

(73) Assignee: VALEO SYSTEMES DE CONTROLE MOTEUR, Osny (FR)

(21) Appl. No.: 10/555,608

(22) PCT Filed: May 6, 2003
(86) PCT No.: PCT/FR03/01401

§ 371 Date: Dec. 14, 2006

(51) Int. Cl. H01H 47/00

(52) U.S. Cl. 361/160

(57) ABSTRACT

The method of preadjusting an electromagnetic actuator comprising an actuator member (12) that is movable between a first extreme position (51) and a second extreme position (52), return means acting on the actuator member to bring it towards an equilibrium position that is intermediate between the first and second extreme positions, and adjustment means (16) for adjusting equilibrium position, comprises the steps of:
for a parameter representative of different positions of the actuator member (12), determining two characteristic values (55, 56) corresponding to the extreme positions (51, 52) of the actuator member (12);
determining a target value from the two characteristics values (55, 56); and
moving the equilibrium point so as to bring it into a preadjustment position (57) in which the representative parameter has a preadjustment value that is substantially equal to the target value.

The invention relates to a method of preadjusting an electromagnetic actuator.

### BACKGROUND OF THE INVENTION

In the automotive field, electromagnetic valve actuators are known that comprise an actuator member acting on the valve that is mounted to move between two extreme positions on either side of an equilibrium point defined by return means acting on the actuator member.

The actuator also includes an electromagnetic member comprising an armature connected to the actuator member and coils which are disposed to attract and hold the armature against abutments, generally defined by respective magnetic cores, serving to define the extreme positions of the actuator member.

The dynamic behavior of the actuator depends on the position of the equilibrium point. The actuator includes adjustment means enabling the equilibrium point to be moved. The equilibrium point is adjusted using a dynamic method of fine adjustment during which the actuator is caused to operate. However implementing that method of fine adjustment assumes that the equilibrium point is already placed initially within an acceptable range of positions that enable the actuator to start and to run.

For this purpose, a method is known of manually preadjusting the actuator by moving the equilibrium point of the actuator member to a predetermined position by measuring the distance of the armature relative to the abutments by means of spacers inserted between the abutments and the armature. That method is difficult to apply on an industrial scale.

U.S. Pat. No. 5,804,962 discloses a method of adjusting the equilibrium point of the actuator member of a two-coil actuator, which method consists in measuring the induction of each coil while the armature is in contact with the corresponding coil. One of the measured values, or the difference between the two measured values is then compared with a predetermined target value. That comparison makes it possible to deduce an offset to be applied to the position of the equilibrium point of the actuator member.

In order to be implemented, that method thus requires the target value to be predetermined, either by modeling, or by taking measurements on a batch of already-adjusted actuators. In addition, the same target value is used for all of the actuators to be adjusted, whereas the position of the equilibrium point of the actuator member is specific to each actuator.

### OBJECT OF THE INVENTION

A particular object of the present invention is to mitigate that drawback.

### BRIEF SUMMARY OF THE INVENTION

To this end, the preadjustment method of the invention comprises the steps of:

for a parameter representative of different positions of the actuator member, determining two characteristic values corresponding to the extreme positions of the actuator member;

determining a target value from the two characteristics values; and

moving the equilibrium point so as to bring it into a preadjustment position in which the representative parameter has a preadjustment value that is substantially equal to the target value.

Thus, the target value is no longer predetermined, but is deduced directly from the measured characteristic values. The target value as deduced in this way is thus specific to each actuator.

The use of a suitable representative parameter makes it easy to determine the preadjustment position that will enable the actuator to start and operate.

In a particular implementation of the method of the invention, the target value is equal to a mean of the characteristic values.

In an advantageous implementation of the method of the invention, the equilibrium point is moved while measuring the representative parameter.

This operation makes it possible to verify that the equilibrium point is properly positioned while measurement is taking place.

In a first particular implementation of the method of the invention, in order to determine at least one of the characteristic values of the representative parameter, the actuator member is brought into the corresponding extreme position, and the representative parameter is measured while the actuator member is in said position.

In another particular implementation of the method of the invention, in order to determine at least one of the characteristic values of the representative parameter, maximum and minimum theoretical values are determined that can be taken by the representative parameter given manufacturing and assembly tolerances, and a mean of the theoretical values is taken as the characteristic value.

In a preferred implementation of the method of the invention, the parameter is an electrical signal coming from a sensor for sensing the position of the actuator member.

### BRIEF DESCRIPTION OF THE DRAWINGS

Other characteristics and advantages of the invention appear in the light of the following description of particular and non-limiting implementations of the invention given with reference to the accompanying figures, in which:

FIG. 1 is a section view of an electromagnetic actuator;

FIG. 2 is a diagrammatic graph showing a first implementation of the adjustment method of the invention; and

FIG. 3 is a graph analogous to FIG. 2 showing a second implementation of the method of the invention.

### DETAILED DESCRIPTION OF THE INVENTION

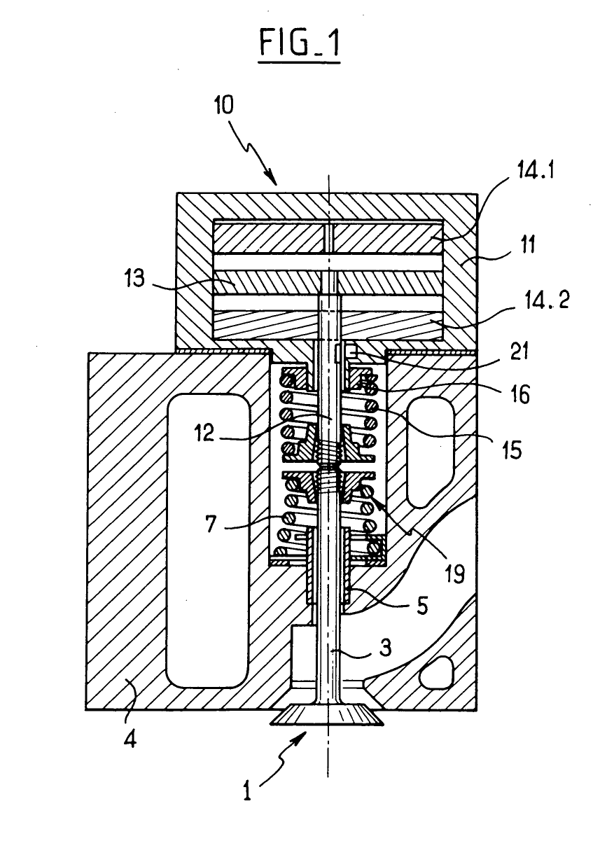

With reference to FIG. 1, and in conventional manner, an electromagnetic actuator 10 is mounted on a cylinder head 4 of an engine in order to actuate a valve 1. The stem 3 of the valve 1 is mounted to slide in a bearing 5 in the cylinder head 4.

The actuator 10 comprises a pusher 12 that acts on the stem 3 of the valve. The end of the stem 3 of the valve 1 and the end of the pusher 12 are urged towards each other by two opposing springs 7 and 15 acting respectively on the pusher 12 and on the valve stem 3. The springs 7 and 15 define an equilibrium point, corresponding to the valve 1 being in a half-open position.

The pusher 12 is secured to an armature 13 mounted to move between two coils 14.1 and 14.2. The stroke of the pusher 12 is limited between a top extreme position defined by the armature 13 coming into abutment against the core of the coil 14.1, and a bottom extreme position defined by the armature 13 coming into abutment against the core of the coil 14.2, the two extreme positions corresponding substantially to the valve 1 being in an open position and being in a closed position.

In operation, the pusher 12 is moved from one extreme position to the other by the combined action of the springs 7 and 15, and of the coils 14.1 and 14.2 attracting the armature 13 in alternation. In order to measure the positions of the pusher 12, the actuator is fitted with a position sensor 21, e.g. Hall effect sensor comprising permanent magnets carried by the pusher 12 and a detector carried by the housing 11 of the actuator.

The spring 15 bears against a seat 16 occupying a position relative to the housing 11 that is adjustable by screw means, under the control of a thumbwheel (not shown). By moving the seat 16, it is possible to move the equilibrium point of the pusher 12.

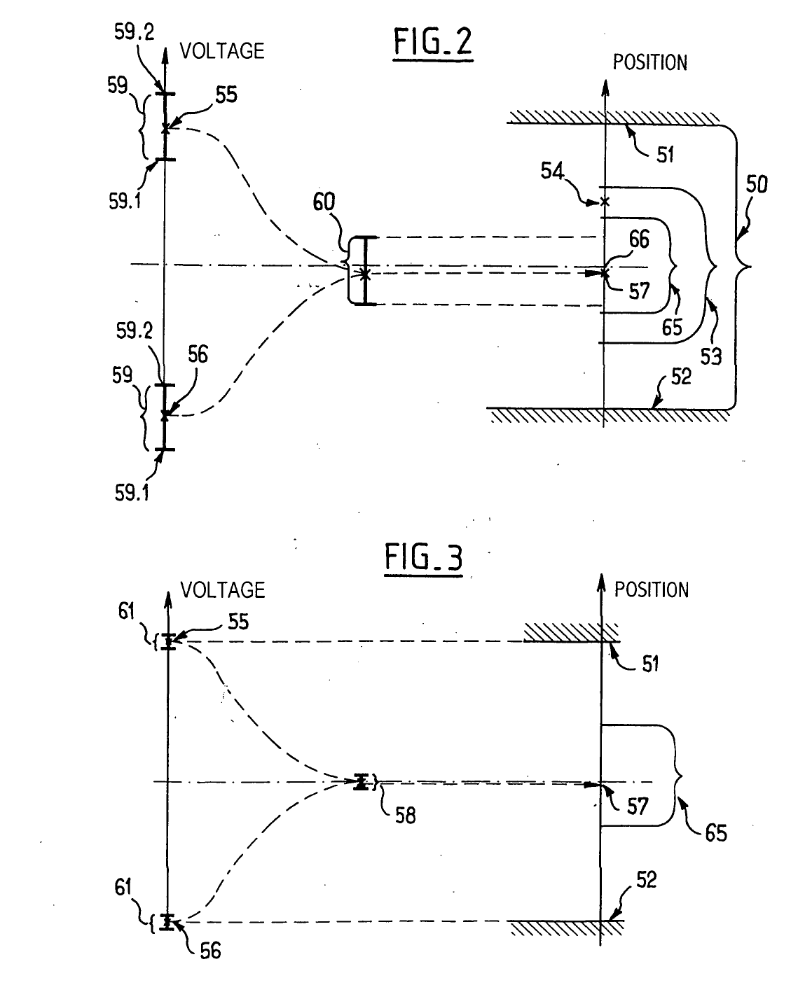

With reference to FIG. 2, in which the positions of the armature 13 are identified on the position axis on the right-hand side, the armature 13 can take any position in a range 50 defined by the top extreme position 51 and the bottom extreme position 52.

Because of manufacture and assembly tolerances that apply to the component elements of the actuator and of the engine, and also because of mounting tolerances concerned with mounting the actuator on the engine, the position of the equilibrium point of the armature 13 after the actuator has been mounted on the engine lies somewhere in a range 53. The amplitude of this range can be very large (up to half the range 50) because of the wide dispersion in the preparation of the springs 7 and 15. Under these circumstances, prior to implementing the method of the invention, the equilibrium point is an initial position 54 in which the armature 13 is too far away from the coil 14.2 to enable it to be attracted thereto, thus preventing any transition of the armature from one extreme position to the other. The actuator cannot operate.

The method of the invention seeks to bring the equilibrium point into a range 65 of acceptable positions that enable the actuator to start and to operate, thus making it possible subsequently to implement a dynamic fine adjustment method that is itself known.

To do this, the method of the invention comprises a step of determining a “top” characteristic value 55 for the voltage across the terminals of the position sensor 21, with this top characteristic value corresponding to the top extreme position 51. A “bottom” characteristic value 56 for the voltage across the terminals of the position sensor 21 is likewise determined, corresponding to the bottom extreme position 52.

The terms used for qualifying the characteristic values serve to associate each of them with the corresponding extreme position, however it should be understood that these terms do not necessarily relate to the real relationship between these characteristic values. In particular, the voltage having the top characteristic value could be less than the voltage having the bottom characteristic value.

In FIG. 2, the top characteristic value 55 and the bottom characteristic value 56 are marked on a voltage axis on the left-hand side of the figure, and placed in correspondence with the extreme positions associated with the position axis on the right-hand side of the figure.

The method of the invention consists in moving the equilibrium point so as to place it in a preadjustment position 57 that lies within the operating range 65 and that corresponds to a voltage value on the sensor 21 that is substantially equal to the mean of the top and bottom characteristic values 55 and 56.

In order to determine the characteristic values 55 and 56 for the voltage across the terminals of the position sensor 21, several techniques are possible within the method of the invention.

In a first technique, the characteristic values 55 and 56 are obtained by calculation, estimating a theoretical minimum value 59.1 and a theoretical maximum value 59.2 that can be taken by each of the characteristic values. The theoretical maximum and minimum values define a range of uncertainty 59 that results from manufacturing tolerances on all of the elements that might have an influence on the associated characteristic value. The characteristic value is then estimated by taking the mean of the corresponding theoretical values 59.1 and 59.2.

The preadjustment voltage 57 as obtained in this way is associated with an uncertainty range 60 that is substantially equivalent to the uncertainty range 59.

Although in the example shown the uncertainty range 60 corresponds to an uncertainty range in the preadjustment position 57 that lies within the range 65 of acceptable positions, it can be advantageous to approach the ideal equilibrium position 66 that lies substantially halfway between the extreme positions 51 and 52, so as to be certain that the actuator will start.

To reduce the uncertainty, and in a second technique as shown in FIG. 3, the characteristic values 55 and 56 are obtained by bringing the armature 13 into abutment against the corresponding coil at the extreme position in question, and measuring the voltage across the terminals of the position sensor 21 when the armature 13 is in abutment.

This technique serves to reduce the uncertainty on the characteristic values 55 and 56 very considerably, since the uncertainty is then restricted to the measurement accuracy of the sensor 21, giving rise to an uncertainly range 61 that is small in comparison with the amplitude of the range 65 of acceptable positions.

In a first variant of this technique, the characteristic values 55 and 56 are measured in the workshop where the actuator is assembled, prior to the actuator being mounted on the engine.

The bottom characteristic value 56 is obtained by measuring the voltage across the terminals of the position sensor 21 while the armature 13 is naturally in abutment against the coil 14.2 since the pusher 12 is subjected to the action of the spring 15 only.

For the top characteristic value 55, advantage is taken of the fact that the actuator is generally delivered with a spacer interposed between the armature 13 and the coil 14.2 enabling the pusher 12 to be held in a retracted position.

To put the spacer into place in the assembly workshop, the corresponding coil 14.1 of the actuator is powered so as to attract the armature 13 into abutment in the top extreme position 51. The voltage is then measured across the terminals of the sensor 21 while the armature 13 is held in abutment in the top extreme position 51.

In a second variant of this technique, the characteristic values are measured once the actuator is mounted on the engine.

For the top characteristic value 55, advantage is taken of the fact that it is necessary to remove the blocking spacer after the actuator has been mounted on the engine. To do this, the coil 14.1 of the actuator is powered so as to attract the armature 13 into abutment in the top extreme position 51. The voltage across the terminals of the sensor 21 is then measured while the armature 13 is held in abutment in the top extreme position 51.

For the bottom characteristic value 56, care is initially taken to move the equilibrium point so that it is closer to the bottom extreme position 52 than to the top extreme position 51. Thus, when the spacer is removed and the armature 13 is released by the coil 14.1, the armature 13 is propelled by the spring 15 towards the coil 14.2 and touches it. The voltage across the terminals of the position sensor 21 is then measured at the moment when the armature 13 touches the coil 14.2. This measurement can be taken on the fly. It is also possible to hold the armature temporarily against the coil 14.2 in order to take the measurement. The prior offset of the equilibrium point guarantees that the armature 13 does indeed touch the coil 14.2.

Numerous variants of the method of the invention are possible, and in particular:

a first implementation in which the two characteristic values are calculated;

a second implementation in which the top characteristic value 55 is measured in the assembly workshop before the actuator is mounted on the engine, while the bottom characteristic value 56 is calculated;

a third implementation in which the top characteristic value 55 is measured after the actuator has been mounted on the engine, while the bottom characteristic value 56 is calculated;

a fourth implementation in which both characteristic values 55 and 56 are measured in the assembly workshop prior to mounting the actuator on the engine; and

a fifth implementation in which both characteristic values 55 and 56 are measured after the actuator has been mounted on the engine.

In order to perform the step of preadjusting the armature, several variants are possible.

In a preferred implementation, the voltage across the sensor is measured while preadjustment is taking place and the equilibrium point is moved until the desired equilibrium point has been reached.

In an open-loop variant, the characteristic values and their average are determined, and then an initial voltage value is measured corresponding to the initial position of the equilibrium point. This voltage is measured after the actuator has been mounted on the engine, and after the spacer has been withdrawn and the pusher 12 has stabilized at the equilibrium point.

A position offset is then determined that corresponds to the difference between the initial value and the desired value. If the position sensor 21 is linear, then the position offset is proportional to the difference. The equilibrium point of the pusher 12 is then moved by turning the adjustment thumbwheel by an amount that corresponds to the desired offset.

The invention is not limited to the particular implementations described above, but on the contrary extends to cover any variant coming within the ambit of the invention as defined by the claims.

In particular, although in the implementations illustrated the sensor delivering the representative parameter is permanently mounted on the actuator, the sensor could be mounted on the actuator in detachable manner for the purpose of measuring the positions of the actuator member while performing the method of the invention.

Although the actuator member as described herein is constituted by a pusher, the invention also applies to an actuator in which the actuator member is a lever.

Although it is stated that when determining characteristic values by calculation each of the characteristic values is obtained as a mean of potential theoretical values of the representative parameter for the associated extreme position, it is also possible to combine the maximum and minimum theoretical values defining the range of uncertainty in which the theoretical values lie, e.g. by using a weighted mean with coefficients that take account of a statistical distribution for the theoretical values in the range of uncertainty.

1. A method of preadjusting an electromagnetic actuator comprising an actuator member (12) that is movable between a first extreme position (51) and a second extreme position (52), return means acting on the actuator member to bring it towards an equilibrium position that is intermediate between the first and second extreme positions, and adjustment means (16) for adjusting equilibrium position, the method comprising the steps of:
for a parameter representative of different positions of the actuator member (12), determining two characteristic values (55, 56) corresponding to the extreme positions (51, 52) of the actuator member (12);
from the two characteristic values (55, 56), determining a target value for the representative parameter for the equilibrium position of the actuator member; and
moving the equilibrium point so as to bring it into a preadjustment position (57) in which the representative parameter has a preadjustment value that is substantially equal to the target value.

2. A method according to claim 1, wherein the target value is equal to a mean of the characteristic values (55, 56).

3. A method according to claim 1, wherein the equilibrium point is moved while measuring the representative parameter.

4. A method according to claim 1, wherein, in order to determine at least one of the characteristic values (55, 56) of the representative parameter, the actuator member (12) is brought into the corresponding extreme position (51, 52), and the representative parameter is measured while the actuator member (12) is in said position.

5. A method according to claim 4, wherein the two characteristic values (55, 56) are obtained by taking measurements in the workshop after the actuator has been assembled.

6. A method according to claim 1, wherein, in order to determine at least one of the characteristic values (55, 56) of the representative parameter, maximum and minimum theoretical values (59.2 and 59.1) are determined that can be taken by the representative parameter given manufacturing and assembly tolerances, and a mean of the theoretical values (59.1, 59.2) is taken as the characteristic value.

7. A method according to claim 6, the two characteristic values (55, 56) are obtained by calculation.

8. A method according to claim 1, wherein the determination of the characteristic values comprises the steps of moving the equilibrium point towards the second extreme position, measuring the characteristic value for the first extreme position, releasing the actuator member, and measuring the characteristic value when the actuator member passes through the second extreme position.

9. A method according to claim 1, wherein the representative parameter is an electrical signal delivered by a position sensor (21) for sensing the position of the actuator member (12).

10. A method according to claim 1, comprising the steps of:
measuring an initial value of the representative parameter corresponding to an initial position (54) of the equilibrium point, and determining a position offset corresponding to the difference between the target value and the initial value of the representative parameter; and
moving the equilibrium point by an amount equal to said position offset.
